(19) United States
(12) Patent Application Publication
(10) Pub. No.: US 2015/0345154 A1
(43) Pub. Date: Dec. 3, 2015

(54) STRUCTURAL ELEMENT FOR THE FORMATION OF A FLOOR AND/OR WALL COVERING AND METHOD FOR THE PRODUCTION THEREOF

(71) Applicant: ARSRATIO HOLDING GMBH, Innsbruck (AT)

(72) Inventor: Claus PERMESANG, München (DE)

(21) Appl. No.: 14/654,746

(22) PCT Filed: Dec. 23, 2013
(86) PCT No.: PCT/EP2013/077891

§ 371 Date: Jun. 22, 2015

(30) Foreign Application Priority Data
Dec. 21, 2012 (DE) 10 2012 112 831.6

(51) Int. Cl. E04F 15/10; B29C 70/68; B32B 5/18; B29C 70/78

(52) U.S. Cl. CPC E04F 15/10; E04F 15/107; B29C 70/78; B29C 70/682; B32B 5/18; B29L 2031/732

(57) ABSTRACT

A structural element for the formation of a floor and/or wall covering having a decorative layer with at least one decorative element and having a carrier layer connected to the decorative layer and provided for bearing on the floor or the wall. The carrier layer has a cast material solidified in a molding space, which forms the carrier layer, with direct attachment to the decorative layer. In a method for producing such a structural element, the at least one decorative element is arranged in a mold adjoining a molding space forming the carrier layer, and a cast material which solidifies with attachment of the carrier layer to the at least one decorative element is introduced into the molding space.

The invention pertains to a structural element for the formation of a floor and/or wall covering with at least one decorative layer comprising at least one decorative element and with a carrier layer, which is bonded to the decorative layer and is intended to rest on the floor or wall.

The invention also pertains to a method for the production of a structural element of this type.

EP 1 682 733 B1 describes these types of structural elements, which can be used to produce floor and/or wall coverings with little effort, and which can be removed so that the structural elements can be recycled. The decorative layer, which can consist of one or more tiles, for example, is bonded by way of an intermediate layer to the carrier layer, wherein this intermediate layer is produced in the mold space formed between the two layers, i.e., the decorative layer and the carrier layer, present in the mold. In the same work step as that in which the intermediate layer is produced, joint fillers and connecting elements are molded onto the structural element, thus becoming integral parts of the intermediate layer. By way of hook-shaped connecting elements, the structural elements can be connected to each other along their edges, wherein the joint fillers, also formed out of the material of the intermediate layer, seal off the butt joints between the structural elements. Because of their weight, the solid carrier layers of the structural elements, possibly formed with the use of recycled plastic material, ensure that the covering rests firmly on the support flooring.

The invention is based on the goal of creating a new structural element of the type described above which is adapted to the production of portable floor and/or wall coverings and which can be produced with less effort than that required according to the prior art.

The structural element according to the invention which achieves this goal is characterized in that the carrier layer comprises casting material which solidifies in the mold space to form the carrier layer and thus bonds the carrier layer directly to the decorative layer.

According to the invention, the advantage is obtained that not only an intermediate layer, as in the prior art, but the entire carrier layer is produced in the mold space of the mold. The structural element now consists only of the decorative layer and the carrier layer. According to the invention, the casting material which solidifies in the mold space and thus forms the carrier layer ensures a direct bond between the two layers. The carrier layer therefore no longer consists of a separate, prefabricated plate element as in the prior art but rather is formed in is entirety, at least in its general shape, by the filling of the mold space with the casting material. The carrier layer itself comprises the intermediate layer known from the prior art, the bonding function of which it partially assumes when it bonds to the decorative layer.

Whereas the entire carrier layer, if desired, could be produced out of the casting material alone, in an especially preferred embodiment of the invention it is possible to embed a filler material in the casting material of the carrier layer. This offers the advantage that this filler material can considerably reduce the amount of casting material required to produce the structural element, while the strength of the carrier layer at least remains the same.

Whereas the filler material could be, for example, a solid plate to be embedded in the casting material, in a preferred embodiment of the invention, filler material in the form of a loose bed of particulate material through which the casting material can permeate is introduced into the mold space; the particles are then more-or-less uniformly distributed in the solidified casting material, and the casting material forms a matrix surrounding the particles.

Depending on the requirements, the material composition of such a loose particle bed can vary. If essentially only a filling function to reduce the required amount of casting material is important, fine gravel or sand, for example, would be suitable. If, however, what is important is to reinforce the strength of the carrier layer or to increase its thermal conductivity, then scrap metal, for example, could be used. At present, the preferred filling and reinforcing substances are plastics obtained from recycling processes.

Material compositions of different types can therefore be used to obtain products with different properties with respect to their thermal insulating behavior, thermal conductivity, load-bearing capacity, sound damping, weight of the structural element, heatability, etc. Such properties can, for the first time, be easily adjusted directly during the production process by the targeted use of different additives, wherein the range of possible variations is nearly limitless.

In all cases, the important point is that the loose bed of particles should be of such a nature that enough free space remains between the particles to allow the casting material to permeate through them.

Alternatively or in addition, a filler of stranded material could be used, especially for reinforcing purposes, wherein in particular a reinforcing mesh would be especially useful. A 2-dimensional reinforcing mesh could be made into a 3-dimensional structure in such a way that it extends over a significant portion of the thickness of the carrier layer.

Fibers such as steel fibers, glass fibers, or carbon fibers can also be considered for use as reinforcing elements extending 3-dimensionally through the casting material, wherein such fibers can also be combined into a reinforcing mat. Alternatively, a 3-dimensional web is formed, which is permeated by the casting material. An especially strong reinforcing effect can be obtained by spinning the web closely so that there is only a small percentage of voids and by spinning the web out of metal in the manner of a scouring pad, for example. In the case of a coarse-mesh web, it would be conceivable that its voids could be filled with fine bulk material, e.g., ground polyurethane scrap or the like.

Polyurethane is especially suitable as the casting material. A foamed (or foaming) plastic material, especially polyurethane foam, can also be considered.

In one embodiment with a 3-dimensional reinforcing mesh, the amount of casting material required could also be reduced by foaming, wherein the 3-dimensional reinforcement compensates for the loss of strength of the casting material associated with foam.

It is obvious that, as in the case of the aggregate, it is also possible to adapt the chemical composition of the casting material and its physical parameters to the desired product parameters, to vary the compositions and parameters even during the production process, and to allow these factors to influence each other. The production method according to the invention can therefore be adapted with little effort to a large number of product variants.

The at least one decorative element can be held in place in the mold at the desired distance from the bottom of the mold space by spacer elements.

The bottom of the mold is preferably adjustable relative to the spacer elements, so that, when the mold is used for the production of different types of structural elements, the total thickness of the different structural elements can advantageously be kept the same.

The previously mentioned mold space can also be used for molding connecting elements, joint fillers, and/or sealing elements onto the structural element, wherein this molding-on process preferably takes place in the same work step as the formation of the carrier layer and uses the same casting material. Alternatively, a separate molding process with the use of a different casting material would also be possible.

Advisably, the areas of the mold space where connecting elements are molded in place will be kept free of filler material. Alternatively, a suitable bulk material filler through which the casting material can permeate could also extend to these areas.

In one embodiment of the method, the areas of the mold space to be kept free are kept separate from the filler material by a structure, especially a meshwork structure, through which the casting material can permeate.

The casting material is advisably introduced into the mold space via the previously mentioned free areas, so that a flow is created which keeps the bulk particulate material away from the areas to be kept free. Alternatively, the casting material could be introduced into an area of the mold space provided with filler material, especially a central area of the mold space.

It is obvious that bulk material layers of different materials can be embedded in one and the same carrier layer of a structural element according to the invention. In addition, different casting materials can also be used, which are introduced into the mold space at different times.

The invention is explained in greater detail below on the basis of exemplary embodiments and the attached drawings, which refer to these exemplary embodiments:

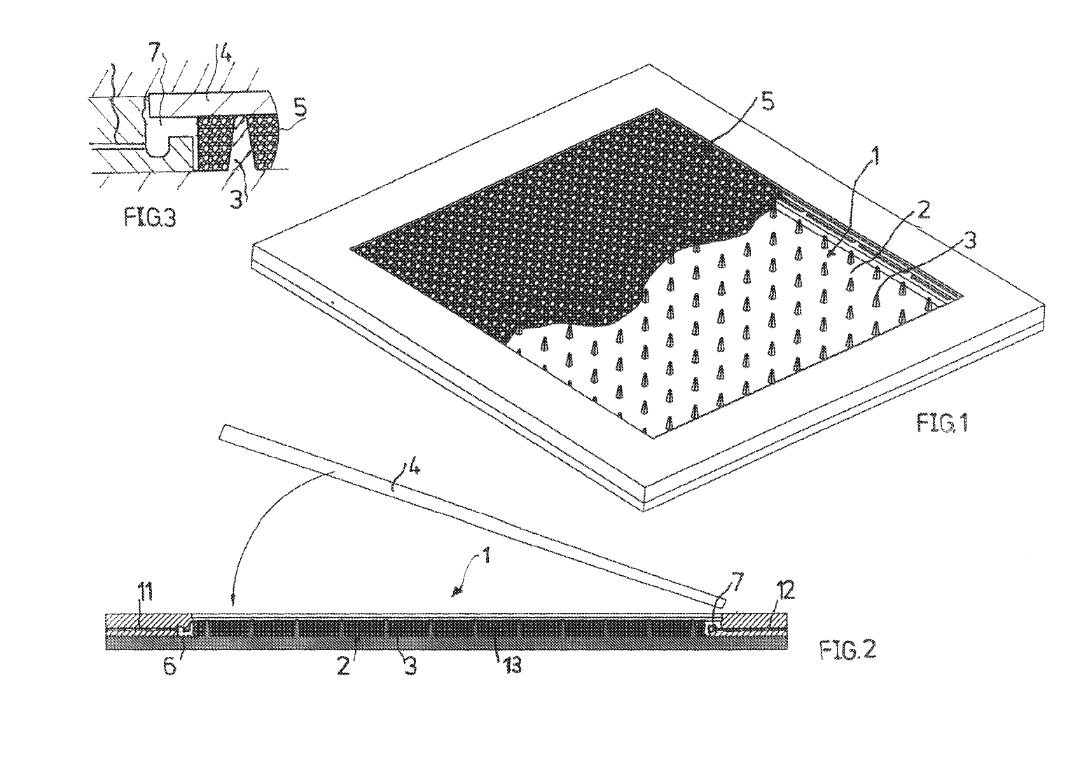

FIG. 1 shows a partial perspective view of a mold for the production of a structural element according to the invention;

FIG. 2 shows a cross-sectional side view of the mold of FIG. 1;

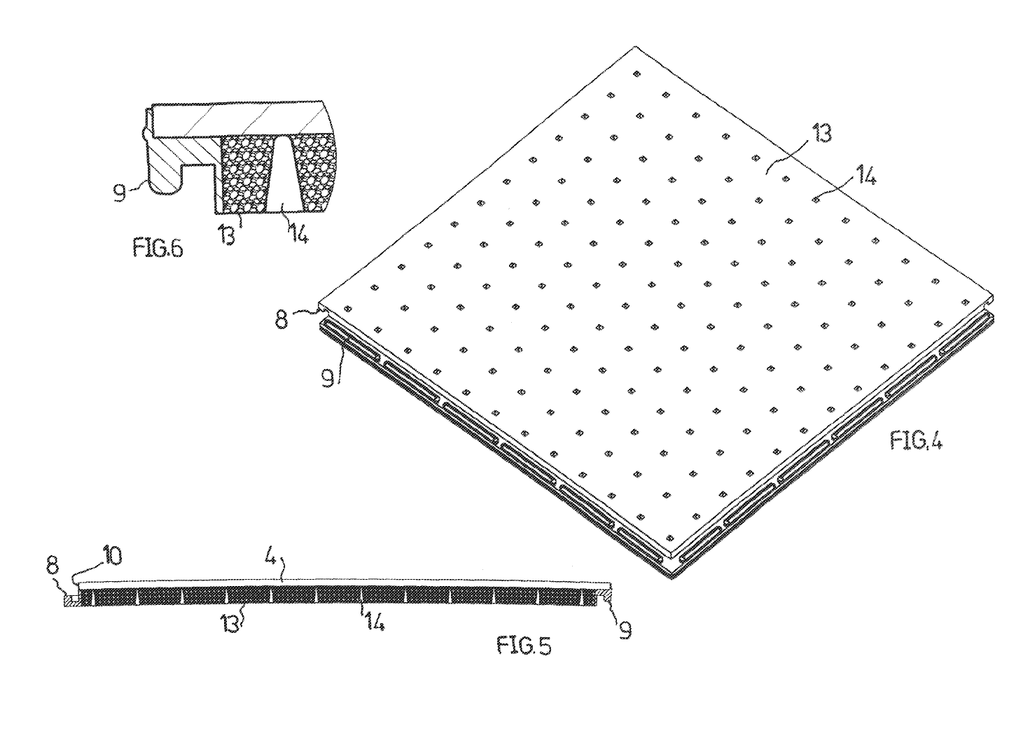

FIG. 3 shows a cross-sectional view of a detail of the mold of FIG. 1;

FIG. 4 shows a perspective view, from underneath, of a structural element according to the invention produced by means of the mold of FIG. 1;

FIG. 5 shows a cross-sectional side view of the structural element of FIG. 4;

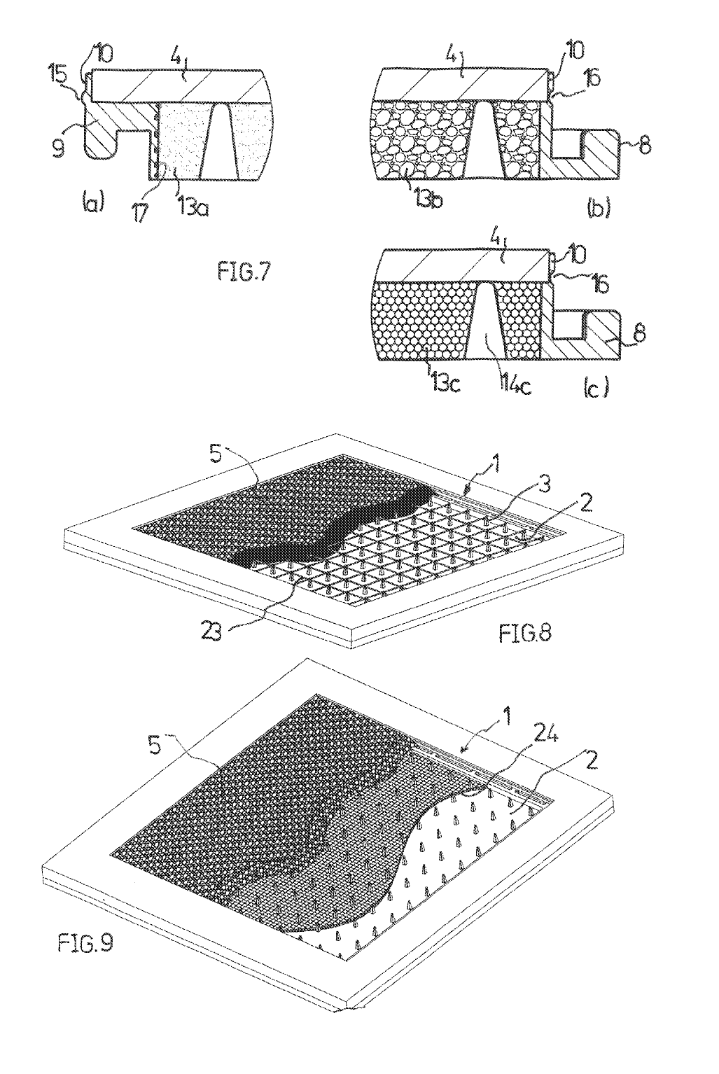

FIG. 6 shows a cross-sectional view of a detail of the structural element of FIG. 4;

FIG. 7 shows additional cross-sectional views of details of exemplary embodiments of structural elements according to the invention;

FIG. 8 shows the mold of FIG. 1, in which a reinforcing grid has been laid;

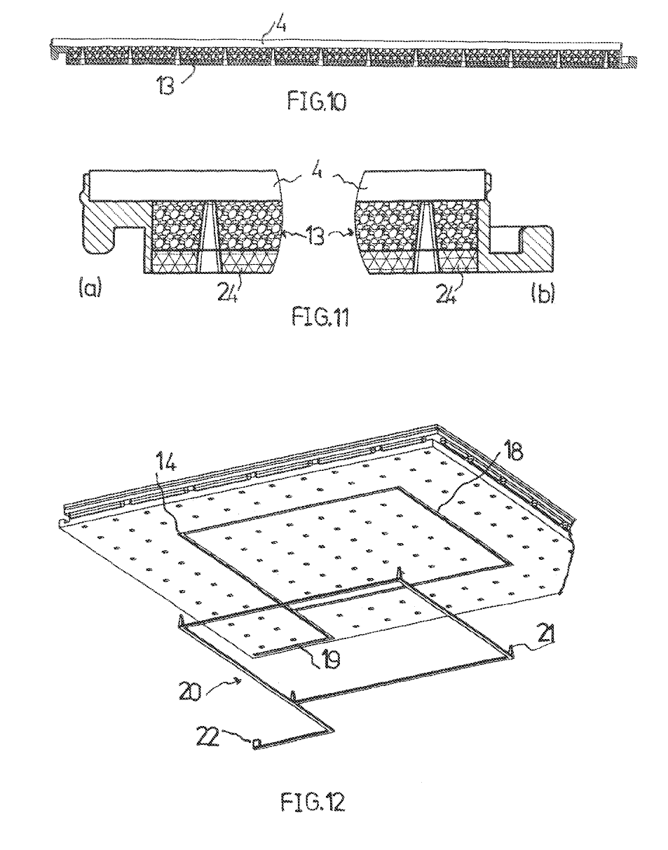

FIG. 9 shows the reinforcing grid of FIG. 1, in which a glass fiber mat has been laid;

FIG. 10 shows a structural element according to the invention produced by means of the mold of FIG. 9;

FIG. 11 shows views of details of the structural element of FIG. 10;

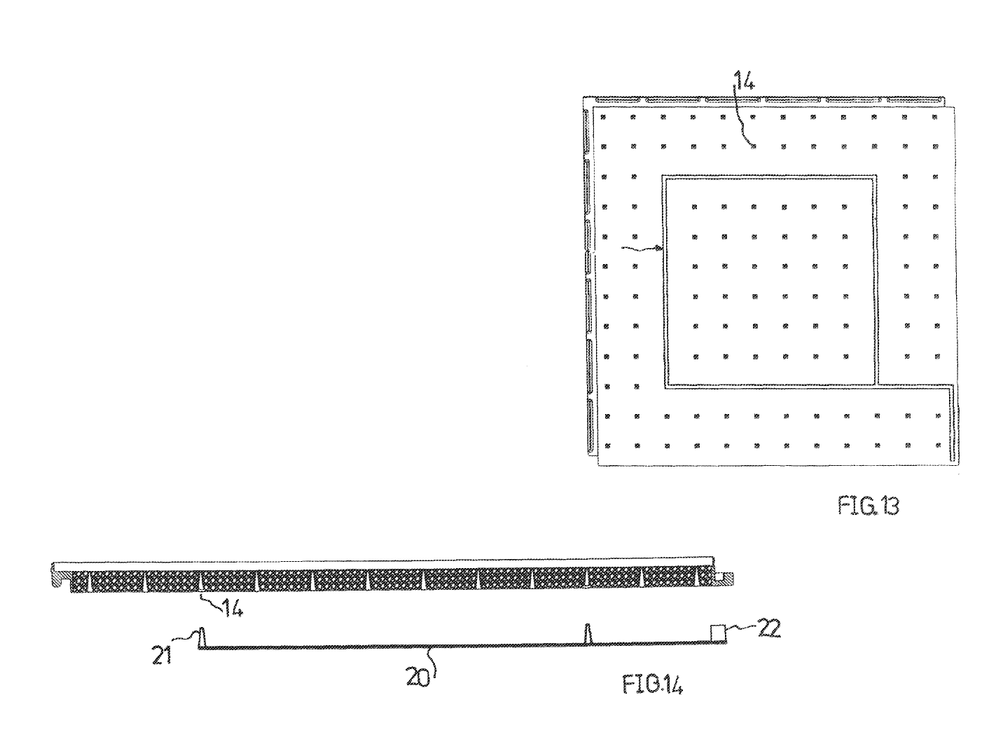

FIG. 12 shows an exploded, perspective view of another structural element according to the invention comprising sensors;

FIG. 13 shows a view of the structural element of FIG. 8 from underneath; and

FIG. 14 shows an exploded, cross-sectional side view of the structural element of FIG. 8.

A mold for the production of a plate-shaped structural element serving to form a floor and/or wall covering shown partially in FIGS. 1-3 comprises a flat mold space 1, from the bottom 2 of which project tapered spacer pins 3. A decorative element 4 to be arranged in the mold space 1 can be laid on the spacer pins 3. This decorative element forms a decorative layer of the structural element to be produced in the mold. The bottom 2 of the mold space 1, which is flat in the example shown here, could also be contoured.

The decorative element 4 can be a plate made of ceramic, plastic, natural stone, metal, wood, or glass. Instead of a single decorative element, it would also be possible to arrange several plate-shaped decorative elements to form the decorative layer. It would also be possible to form a decorative layer out of a plurality of irregularly shaped elements such a layer of pebbles. In the extreme case, the decorative layer is formed by an especially decorative filler material.

To produce a structural element like that shown in FIGS. 4-6, a filler material 5 is introduced into the flat mold space 1; in the exemplary embodiment shown here, this filler material is a loose bed of particles, between which there are open spaces through which a casting material, to be introduced into the mold space 1 from at least one side, can permeate.

An example of suitable filler material is ground-up plastic waste. Also possible, however, would be fine gravel, a bed of glass beads, sand, ground-up metal scrap, metal balls of various sizes, possibly hollow balls to reduce the weight, and other materials as well.

The filler material bed 5 does not completely fill the mold space 1. At its edge, free areas 6 and 7 remain, which serve to accept the molded-on hook-shaped connecting elements 8 and 9 and a peripheral butt-joint filler 10 on the decorative element 4. Alternatively, it would also be possible to fill the areas 6 and 7 with aggregate.

As FIGS. 2 and 3 show, lines 11 and 12 for supplying casting material lead into the areas 6 and 7, so that the casting material first fills the areas 6, 7 before it permeates the filler material bed 5. The advantage of this is that the filler 5 is prevented from reaching the areas 6, 7. Lines for supplying casting material could also be laid to some other point in the mold space, however, e.g., from the front and/or rear of the mold to the central area of the mold space.

In the example described here, polyurethane components which solidify in the mold space are preferably supplied as casting material; the components are mixed together shortly before they are introduced. Single-component materials would also be possible.

The casting material introduced into the mold space, where it solidifies, completely permeates the bed of filler material 5 before it solidifies; and, after solidification, it forms a matrix enclosing the particles of the bed. In addition to the formation of a solid carrier layer 13 of the structural element, the solidifying casting material also ensures a strong bond between the carrier layer 13 and the decorative element 4, so that a stable structural element is obtained.

To unmold the plate-shaped structural element, it is lifted from the bottom 2 of the mold space 1, wherein the spacer pins 3 leave behind corresponding recesses 14 in the bottom of the structural element, as can be seen in FIGS. 4-6. In a first phase of the unmolding process, the spacer pins 3 could serve as ejector elements.

The bottom 2 of the mold is movable, in that it can be shifted in the longitudinal direction of the spacer pins 3, so that, independently of the thickness of the selected decorative element 5, it is possible for the overall thickness of the structural elements to remain constant. Side walls around the edges of the mold space could also be movable, so that structural elements with different edge dimensions can be produced.

FIG. 7 shows parts of various exemplary embodiments of structural elements comprising carrier layers 13a, 13b, 13c with differently structured fillers embedded in the casting material.

Fine aggregates such as sand or metal powder are embedded in the carrier layer 13a. A structure capable of being permeated by the casting material, especially a meshwork structure 17, forms a boundary between the area of the carrier layer 13a provided with aggregate and the areas containing no aggregate. The meshwork structure 17 is permeable to the casting material, but not to the aggregate material. The carrier layer 13b contains coarse aggregate, e.g., recycled polyurethane, metal, or stone material.

Small metal balls are embedded in the carrier layer 13c. Electrical contacts for heating current passing through the metal balls could be fitted into existing recesses 14c.

In addition to hook-shaped connecting elements 8 and 9 and a butt joint filler 10 extending around the periphery of the decorative element 4, FIG. 7 also shows a sealing projection 15 and a groove 16, which accommodates a mating projection on an adjacent structural element.

FIG. 8 shows a mold with reinforcement 23, which, in the examples shown here, is in the form of a steel grid which has been laid in the mold space 1. The reinforcement 23 is placed inside the mold space 1 near the bottom 2 of the mold space, wherein a bed 5 of material surrounds the reinforcement, and spacer pins 3 projects through it.

According to FIG. 9, instead of a metal grid, a woven mat 24, which, in the example shown here, is in the form of a glass fiber mat, has been introduced as reinforcement into the area subject to tensile stress; this glass fiber mat rests on the bottom 2 of the mold space 1.

In the carrier layer 13 of a structural element as shown in FIG. 10 produced in the mold of FIG. 9, both the filler material 5 and the glass fiber mat 24 are permeated by the casting material, and the casting material ensures, among other things, a strong bond between the filler 5 and the reinforcement 24.

A structural element shown in FIGS. 12-14 comprises a ring-shaped channel 18 with a branch 19; the channel is open to the support surface. The ring-shaped channel 18 connects recesses 14, which are necessary for fabrication reasons.

A sensor bracket 20 with four sensors 21, each of which can be introduced into an opening, is introduced into the ring-shaped channel 18 with the branch 19. The sensor bracket 20 also comprises at least one plug element 22, which is located in a recess in one of the connecting elements 8 and/or 9.

The sensors can be configured to detect the loads on the structural element, temperatures, and/or acoustic effects.

During the production of a floor covering, all of the sensors of the covering are linked to each other by plug elements 22. Thus, for example, traffic density, unallowable loads, and other parameters can be determined.

In addition, it is possible that a heating element could be fitted into each of the recesses 14 in the same manner as that in which the sensors 21 are provided. The heating elements can be connected to each other and from one structural element to another by way of the branch 19 and elements corresponding to the plug element 22. Instead of a heating element giving off its own heat, it would also be possible to install an electrical contact to conduct heating current through the carrier layer.

1-15. (canceled)

16. A structural element for formation of a floor and/or wall covering, comprising at least one decorative element forming a decorative layer; and a carrier layer bonded to the decorative layer and restable on the floor or the wall, wherein the carrier layer comprises a casting material, which solidifies in a mold space to form the carrier layer and thereby bonds the carrier layer directly to the decorative layer.

17. The structural element according to claim 16, wherein a filler material is embedded in the casting material of the carrier layer.

18. The structural element according to claim 17, wherein the filler material comprises particles distributed in the casting material.

19. The structural element according to claim 16, wherein a filler material serves as reinforcement.

20. The structural element according to claim 19, wherein the reinforcement comprises reinforcing strands.

21. The structural element according to claim 20, wherein the reinforcing strands form a 2-dimensional reinforcing grid.

22. The structural element according to claim 21, wherein a 3-dimensional reinforcing grid is formed from the 2-dimensional grid and extends through an entire thickness of the carrier layer.

23. The structural element according to claim 16, wherein the casting material is polyurethane.

24. The structural element according to claim 23, wherein the polyurethane is polyurethane foam.

25. A method for producing a structural element for formation of a floor and/or wall covering, wherein the structural element includes a decorative layer having at least one decorative element and a carrier layer that is bonded to the decorative layer and is intended to rest on the floor or wall, the method comprising the steps of: arranging at least one decorative element in a mold enclosing a mold space intended to form the carrier layer; and introducing casting material into the mold space for solidifying and bonding the carrier layer to the at least one decorative element.

26. The method according to claim 25, including introducing a filler material into the mold space, which filler material is to be embedded in the casting material.

27. The method according to claim 26, wherein the filler material is introduced as a loose particle bed to be permeated by the casting material.

28. The method according to claim 25, including holding the at least one decorative element a desired distance away from a bottom of the mold space by spacer elements.

29. The method according to claim 25, wherein the mold space molds connecting elements, joint fillers, and/or sealing elements in place on the structural element.

30. The method according to claim 29, wherein areas of the mold space where the connecting elements, joint fillers, and/or sealing elements are molded in place are kept free of filler material.

31. The method according to claim 30, wherein the areas of the mold space which are kept free are separated from the filler material by a structure through which the casting material permeates.

32. The method according to claim 31, wherein the structure is a meshwork structure.

33. The method according to claim 30, wherein the casting material is introduced into the mold space through at least one of the free areas and/or into a central area of the mold space.
